(19) United States
(12) Patent Application Publication
(10) Pub. No.: US 2025/0156883 A1
(43) Pub. Date: May 15, 2025

(54) METHOD FOR AUTHENTICATING AND/OR IDENTIFYING AND/OR TRACING AN OBJECT, IDENTIFICATION ELEMENT AND USE OF SUCH AN IDENTIFICATION ELEMENT FOR SAID METHOD

(71) Applicant: Particular Materials S.R.L., Cadoneghe (IT)

(72) Inventors: Marco BERSANI, Padova (IT); Dario MOSCONI, Rubano (IT); Guido MASOTTI, Milano (IT)

(21) Appl. No.: 18/838,604

(22) PCT Filed: Mar. 17, 2023
(86) PCT No.: PCT/IB2023/052639

§ 371 Date: Aug. 14, 2024

(30) Foreign Application Priority Data
Mar. 17, 2022 (IT) 102022000005210

(51) Int. Cl. G06Q 30/018; G07C 11/00

(52) U.S. Cl. CPC G06Q 30/0185; G07C 11/00

(57) ABSTRACT

A method for authenticating and/or identifying and/or tracing an object, which includes the following steps: a first step of associating a given unique code with a given identification element, on the basis of the concentrations of at least some of the chemical elements that constitute the identification element, a second step of applying/associating the identification element to/with the object, a third step of detecting the unique code by way of detecting the concentrations of the chemical elements that constitute the identification element.

The present invention relates to a method for authenticating and/or identifying an object.

The invention can be applied in an industrial context, both to semi-finished products and to finished products.

The invention can also be used in sectors like clothing, luxury goods, jewelry, pharmaceuticals, perfumery, automotive etc.

Nowadays, in order to combat counterfeiting and the fake market, systems and solutions are widely used which are adapted to guarantee the authenticity of objects and to trace it and detect any transfer between persons.

Widespread among these are security identification elements, visible or partially hidden from view, which can be detected uniquely and reproducibly, or read/measured like authentication codes, for example by way of irradiation techniques using light sources (for example UV).

Such security identification elements can be, for example:
a particular graphic motif, such as a bar code, a QR code, a hologram, a micrograph etc.,
a particular ink or color,
electronic information exchange elements, such as RFID (Radio-Frequency Identification) tags,
labels and/or packaging elements with tamper-evident technology, such as seals, counter-marks or other elements adapted to indicate tampering visibly or audibly, which make it possible to easily detect unauthorized access to the object to which they are applied.

Such conventional techniques all have a number of drawbacks.

First of all, in many such conventional techniques identification elements are used which are not completely hidden from view, and this determines the drawback of needing, in some way, to modify the appearance of the product to which they are applied, with the risk of resulting in an unpleasant visual impact in the user or potential purchaser.

Furthermore, in some product sectors, such as jewelry or metallurgy, using one of these technologies is not conceivable because the appearance of the finished product would be compromised.

Another drawback of such conventional techniques derives from poor mechanical strength and resistance to high temperatures.

This means the security identification elements will be damaged if they are subjected to a minimal rise in temperature or to a mechanical stress, even of modest extent.

In order to overcome such drawbacks, in recent years the makers of anti-counterfeit systems have developed systems based on nanotechnologies which make it possible to hide the identification elements from view.

The term “nanotechnologies” means the branch of science applied to the technology involving the synthesis, engineering, integration and applications of all materials that have at least one dimension comprised between 1 and 100 nanometers.

For example, identification elements are known such as bar codes with fluorescent inks that withstand temperature increases.

However these have the drawback of not being completely hidden from view and they offer a reduced encoding capacity.

In the present description, the expression “encoding capacity” means the number and complexity of items of information that can be associated with or stored in the identification element.

Alternative solutions that are taking hold in the market are, for example, those that involve the use of phase change materials, magnetic nanoparticles, DNA sequences etc., which use identification elements that are invisible to the naked eye.

All these solutions, however, have the drawback that the security identification elements cannot be easily read/detected, it being necessary to use special techniques and apparatuses, often very cumbersome and expensive.

Furthermore, the application of such techniques/apparatuses for reading/detecting the security identification elements involves methods that are lengthy and inconvenient.

The aim of the present invention is to provide a method for authenticating and/or identifying and/or tracing an object that is capable of improving the known art in one or more of the above mentioned aspects.

Within this aim, an object of the invention is to provide a method for authenticating and/or identifying and/or tracing an object in which the identification elements have high thermal resistance and mechanical strength and are not subject to deterioration as a consequence of rises in temperature or mechanical stresses.

Another object of the invention is to provide a method for authenticating and/or identifying and/or tracing an object that makes it possible to use identification elements that are completely hidden from view.

A further object of the invention is to provide a method for authenticating and/or identifying and/or tracing an object that makes it possible to rapidly and easily read/detect the identification elements.

Another object of the invention is to provide a method for authenticating and/or identifying and/or tracing an object that uses identification elements that have a considerable encoding capacity.

Furthermore, the present invention sets out to overcome the drawbacks of the background art in a manner that is alternative and/or supplementary to any existing solutions.

Another object of the invention is to provide a method for authenticating and/or identifying and/or tracing an object that is highly reliable, easy to implement and of low cost.

This aim and these and other objects which will become better apparent hereinafter are achieved by a method for authenticating and/or identifying and/or tracing an object, characterized in that it comprises the following steps:
a first step of associating a given unique code with a given identification element, on the basis of the concentrations of at least some of the chemical elements that constitute said identification element,
a second step of applying/associating said identification element to/with said object,
a third step of detecting said unique code by way of detecting said concentrations of said chemical elements that constitute said identification element.

This aim and these and other objects which will become better apparent hereinafter are achieved by the use of nanoparticles applied to/associated with the raw materials of an object and/or to/with said finished object in order to authenticate/identify/trace it.

This aim and these and other objects which will become better apparent hereinafter are achieved by an identification element for authenticating/identifying/tracing an object, characterized in that it comprises a nanoparticle-based substance adapted to be applied to/associated with the raw materials of said object and/or to/with said finished object.

Further characteristics and advantages of the invention will become better apparent from the detailed description that follows of a preferred, but not exclusive, embodiment of the method for authenticating/identifying an object according to the invention, which is illustrated by way of non-limiting example in the accompanying drawings wherein:

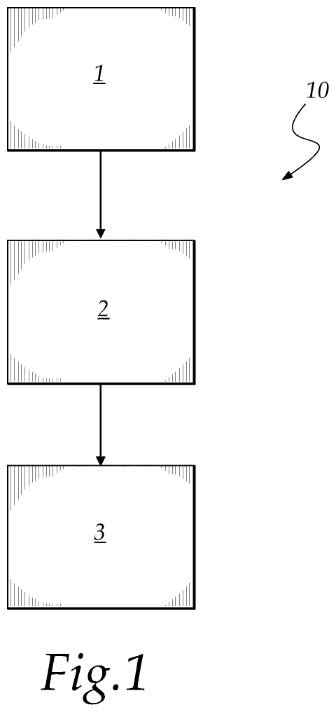

FIG. 1 is a block diagram of a method for authenticating and/or identifying and/or tracing an object, according to the invention.

With reference to the figure, a method for authenticating and/or identifying and/or tracing an object, according to the invention, is generally designated by the reference numeral 10.

The method 10 comprises the following steps:
a first step 1 of associating a given unique code with a given identification element, on the basis of the concentrations of at least some of the chemical elements that constitute such identification element,
a second step 2 of applying/associating the identification element to/with the object to be authenticated and/or identified and/or traced,
a third step 3 of detecting the unique code by way of detecting the concentrations of the chemical elements that constitute the identification element.

The identification element is a nanoparticle-based substance.

Such nanoparticle-based substance is a powder of nanoparticles and/or a paste of nanoparticles dispersed in water and/or solvent.

The identification element is, for example, a powder of nanoparticles, advantageously constituted by an n-ary oxide.

In the present description, the expression “n-ary oxide” means an oxide constituted by a number “n” of elements in variable proportion.

In alternative embodiments of the method 10, the identification element is represented by a nanoparticle-based substance constituted by: hydroxides and/or borides and/or carbides and/or nitrides and/or fluorides and/or silicides and/or phosphides and/or sulfides and/or arsenides and/or selenides and/or antimonides and/or tellurides and/or metallic alloys that are zero-valent, etc.

Such unique code, associated with the identification element, is composed of:
one or more letters, each one identifying a given chemical element of the composition of such nanoparticles,
and/or a plurality of numbers, each one defining the concentration of a respective chemical element of the composition of such nanoparticles.

The letters identifying the chemical elements do not necessarily correspond to the letters that identify the chemical elements in the periodic table of the elements, but can be different and/or encrypted.

Similarly, the numbers that define the concentration of the chemical elements need not correspond to the percentages of the elements in the nanoparticles, but can be different and/or encrypted.

Alternatively, the unique code associated with the identification element is composed of:
a letter that identifies a reference chemical element of the composition of such nanoparticles,
and/or a series of numbers, each one defining the relative concentration, with respect to the reference element, of other elements of the composition which are used as encoding elements.

In the present description, the expression “relative concentration” means the atomic concentration of each individual chemical element with respect to the total concentration of the elements measured.

Advantageously, the chemical elements which compose the identification element are, by way of non-limiting example, lanthanum, cesium, praseodymium, yttrium, dysprosium, neodymium, strontium, europium, gadolinium, zirconium, barium.

It should be noted that, before the application of the method, during the process of production of the powder of nanoparticles of the identification element, by controlling the corresponding ratios between the chemical elements present in the composition during the synthesis of the nanoparticles, it is possible to encode a particular code of interest by way of the relative concentrations of the elements, which are optionally normalized with respect to a reference element included in the composition.

Consider, for example, an identification element (nanoparticle) constituted by the following hexenary oxide:

AₓB_{y}C_{w}D_{z}EⱼOₖ,
where:
   A, B, C, D and E are the chemical elements that constitute the oxide,
   O is oxygen,
   x, y, w, z, j are values that can vary between 0 and 1, representing the concentration of the respective elements A, B, C, D, E in the composition,
   k is the stoichiometric value of the oxygen necessary to balance the valency of the elements A-E.

The unique code associated with such identification element is “AₓB_{y}C_{w}D_{z}Eⱼ”, which can be encrypted according to a code chosen deliberately in advance.

Alternatively, taking the same identification element and:
A as the reference element,
B, C, D and E as encoding elements,
the unique code associated with such element is “Aprst”, where p, r, s and t are the numeric values referring to the relative concentrations of B, C, D and E, with respect to the encoding element A, as a function of the resolution of the technique or of the instrument for detecting the concentrations of the chemical elements that constitute the identification element, during the third step 3.

Advantageously, the third step 3 is performed by way of a preset one of the following techniques and/or apparatuses:
atomic absorption spectroscopy (AAS),
inductively coupled plasma mass spectrometry (ICP-MS),
atomic emission spectroscopy (AES), regardless of the method with which the emission is obtained (for example: electric arc, laser, flame, inductively coupled plasma etc.)
XRF spectrophotometry (X-ray fluorescence spectroscopy), optionally using a portable device,
scanning electron microscope, of the SEM-EDX (Scanning Electron Microscope-Energy Dispersive X-ray Analysis) type.

Each one of these techniques and/or apparatuses has sufficient resolution to distinguish relative concentrations of the encoding elements lower than 10% with respect to the reference element.

In the present description, the term “resolution” means the minimum appreciable variation of the quantity under examination over the entire spectrum measured.

For example, for XRF analysis the resolution is greater than 100 eV.

The resolution in XRF is the ability to distinguish extremely close emission lines.

It should be noted that, as a function of:
the number of the chemical elements used in the composition of the identification element,
the resolution of the techniques and/or apparatuses for detecting the concentrations of the chemical elements that constitute the identification element,
it is possible to encode a considerable number of unique codes.

It should also be noted that by mixing the nanoparticles it is possible to obtain an even greater number of unique codes, by way of defining a plurality of secondary unique codes, that are the result of mixing the nanoparticles.

For the purposes of example, consider the identification element with the composition A₁₀₀B₈₃C₄₇D₆₁E₀₉Oₖ, wherein
A is the reference element,
B, C, D, E are the encoding elements,
O is stoichiometric oxygen,
the subscripts indicate the relative concentrations of the elements considered.

If we use an instrument with a resolution of 10% of the encoding element A, the unique code detected during the third step 3 is “8561”.

With an instrument with a resolution of 10% of the element A, therefore in a decimal system, 104 combinations and a corresponding number of unique codes are possible.

If we use an instrument with a resolution of 5% of the encoding element A, the code detected becomes “179122”.

Therefore, with an instrument with a resolution of 5% of the element A, in a vigesimal system, 20⁴ combinations and a corresponding number of unique codes are possible.

In general we have the following formula:

Number of codes=(100/Percentage resolution)^{(Number of elements in composition-1)}

It should be noted that a method according to the invention enables the use of a high number of unique codes even with a low number of chemical elements at the base of the composition of the identification element.

The second step 2 of applying/associating said identification element to/with the object to be authenticated and/or identified, occurs in one or more of the following ways.

In a first way, the nanoparticle-based substance that constitutes the identification element is introduced and/or embedded in a matrix constituted by the raw material of the object to be authenticated.

This occurs, for example, by way of dispersion:
as an additive in polymeric masterbatches for objects made of plastic material,
in the metallic melted state, in the case of objects made of metallic material, like jewelry.

In particular, the nanoparticle-based substance of the identification element is introduced into the matrix in a percentage by weight that can vary from 0.001% to 10% of the weight of the matrix, and preferably comprised between 0.1 and 1% of the weight of the matrix.

A second way entails a distributed surface application of the nanoparticle-based substance on one or more surfaces of the finished object to be authenticated/identified.

This can occur, for example, on yarns, fabrics, hide, paper and other porous materials that define one or more surfaces of the object to be authenticated/identified/traced.

This occurs by spraying a mixture that comprises:
the nanoparticles that define the identification element,
a solvent,
a dispersant/coupling agent,
other optional binders and/or additives.

Such solvent is, for example, water with the nanoparticles in the order of 0.3% by weight, or ethyl alcohol with the nanoparticles in the order of 0.5% by weight.

Such dispersant/coupling agent is, for example, a wetting agent with a percentage by weight in the order of 10% with respect to the quantity of nanoparticles, or a surfactant agent with a percentage by weight in the order of 10% with respect to the quantity of nanoparticles.

Such dispersant is, for example, the one known by the commercial name of “DISPERBYK® 192”, produced by the BYK Chemie company in Germany.

One binder that can be used in the method 10 is, for example, the one known by the commercial name of “chitosan” produced by the Thermo Scientific company, with a percentage by weight in the order of 1%, and the addition of acetic acid with a percentage by weight in the order of 0.002%.

One additive that can be used in the method 10 is, for example, the surfactant additive known by the commercial name of “BYK®”, produced by the BYK Chemie company in Germany, with a percentage by weight in the order of 0.5% with respect to the total of the formulation.

Other additives that can be used in the method 10 are: plasticizers and/or fluidifying agents and/or colorants and/or spreading agents and/or antistatic agents and/or thickeners agents and/or opacifiers and/or anchoring agents, etc.

Alternatively, it is possible to co-formulate the nanoparticles that define the identification element with an ink for screen printing and/or digital printing and/or for surface decoration and to apply such ink to at least one of the surfaces of the object to be authenticated/identified/traced.

In the present description, the term “co-formulate” means dispersing the nanoparticles in the ink and optimizing the formulation in order to render the ink obtained usable for the printing and/or writing and/or coloring of surfaces.

In a further variation, it is possible to deposit a layer of powder of nanoparticles that constitutes the identification element, by electrochemistry, using a surface treatment of the galvanic type on the object to be authenticated/identified/traced.

In a third way, a label is provided by applying a uniform layer of powder of nanoparticles that constitutes the identification element on a small area, in order to form a tag to be applied locally on the objects to be authenticated/identified/traced such as products, components, labels, documents, etc.

For example, the area of this tag can have dimensions comprised between 0.1 mm² and 5 cm², preferably in the order of 1 cm², with a thickness of the layer of 0.1 mm.

In general, after the second step 2 of the method 10, the percentage by be weight of the identification element on the object to authenticated/identified is, preferably, less than 1%.

It should be noted that, according to the chemical elements chosen to provide the powder of nanoparticles and their concentration in the composition, it is possible to synthesize identification elements of different colors and shades and this makes it possible to choose the identification element that is best adapted and most advantageous for the object to be authenticated/identified/traced, on the basis of the correspondence between the color of the object (at the surface level or of the material from which it is made) and of the identification element.

It should be noted that the nanoparticles of the powder that constitutes the identification element:
are dispersed effectively and evenly in polymeric and/or metallic and/or ceramic and/or vitreous and/or paper matrices, but also on inks,
penetrate deeply, by virtue of their nanometric size, into the porosity and into the surface roughness of the materials on which they are applied.

Furthermore, at the nanometric scale, adhesive forces are very strong, in the order of 100 Mn/m, such that the bond between the nanoparticles and the substrate to which they are applied is stable when subjected to chemical or mechanical actions, within the limits of stability of the substrate.

From experimental tests, it has been found that the transfer of the nanoparticles to the environment and their dispersion therein does not occur, or in any case occurs at a negligible level, according to standardized tests, such as for example:
Tests for skin and intradermal irritation (UNI EN ISO 10993-10);
Tests for in cytotoxicity (ISO 10993-5);
Tests for cellular vitality (ISO10993-1:2018).

It should also be noted that the dimension of the nanoparticles of the powder that constitutes the identification element and its concentration in the matrix or on the surface with which the latter is associated are such as not to produce variations in the optical, mechanical, thermal, chemical behavior of the object to which it is applied.

Furthermore, in the method according to the invention, the nanoparticles of the powder of the identification element are, substantially, chemically inert materials and do not release ions that could start cytotoxic processes or processes that are damaging to the environment.

In the present description, the expression “chemically inert materials” means that the nanoparticles do not start and do not participate in any chemical reactions that occur in the environment in which they are located.

Also, it should be noted that the percentage of the identification element on the object to be authenticated/identified that is preferably less than 1% ensures that such identification element cannot constitute either a risk to human health or a negative environmental impact factor.

In practice, the use of the method for authenticating and/or identifying and/or tracing an object, according to the invention, is the following.

After having synthesized a powder of nanoparticles that constitutes a given identification element, with a given chemical composition, a given unique code is defined/associated with such identification element, on the basis of the concentrations of at least some of its constituent chemical elements.

Then such identification element is associated with/applied to the object to be identified and/or authenticated and/or traced.

When it is necessary to identify/trace the object, a reading/detection is carried out of the unique code associated with the object, by way of the detection of the concentrations of the chemical elements that constitute the identification element associated with/applied to it.

It should be noted that, with a method according to the invention, the identification element can be inserted in all of the material so as to ensure the practical impossibility of counterfeiting given that the very material of which the object is made would need to be tampered with. The identification element and the material of which the object with which it is associated is made are inseparable.

With such method the origin of the object is completely certified and verifiable simply on the basis of the detection of the concentration of some chemical elements in the identification element.

In a variation of embodiment of the method 10, according to the invention, the unique code associated with the identification element is in turn associated with an NFT (Non-Fungible Token), thus effectively creating a connection between the real-world object and a digital certificate that attests to its ownership/origin.

The association between the NFT and the code of the nanoparticle-based substance is achieved by inserting the encrypted code of the identification element into the code string (hash code) that characterizes the NFT, thus irreversibly associating the two elements.

This also enables the end customer to verify the authenticity of the object using a blockchain, whereby the technology for the method according to the invention adds a level of security covering the link between the finished object and its digital certificate.

In practice it has been found that the invention fully achieves the intended aim and objects by providing a method for authenticating and/or identifying and/or tracing an object in which the identification elements have high thermal resistance and mechanical strength and are not subject to deterioration as a consequence of rises in temperature or mechanical stresses.

With the invention a method has been devised for authenticating and/or identifying and/or tracing an object that makes it possible to use identification elements that are completely hidden from view.

Furthermore, with the invention a method has been provided for authenticating and/or identifying and/or tracing an object that makes it possible to rapidly and easily read/detect the identification elements.

Also, with the invention a method has been devised for authenticating and/or identifying and/or tracing an object that uses identification elements that have a considerable encoding capacity.

The invention, thus conceived, is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. 102022000005210 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-18. (canceled)

19. A method for authenticating and/or identifying and/or tracing an object, comprising the following steps:
a first step of associating a given unique code with a given identification element, on the basis of concentrations of at least some of chemical elements that constitute said identification element,
a second step of applying/associating said identification element to/with said object,
a third step of detecting said unique code by way of detecting said concentrations of said chemical elements that constitute said identification element.

20. The method according to claim 19, wherein said identification element is a nanoparticle-based substance.

21. The method according to claim 20, wherein said nanoparticle-based substance is a powder of nanoparticles and/or a paste of nanoparticles dispersed in water and/or solvent.

22. The method according to claim 21, wherein said nanoparticles are constituted by an n-ary oxide and/or hydroxides and/or borides and/or carbides and/or nitrides and/or fluorides and/or silicides and/or phosphides and/or sulfides and/or arsenides and/or selenides and/or antimonides and/or tellurides and/or metallic alloys that are zero-valent.

23. The method according to claim 22, wherein said n-ary oxide comprises a plurality of chemical elements in variable proportions.

24. The method according to claim 19, wherein said unique code is composed of:
one or more letters, each one of which identifies a given chemical element within the composition of said nanoparticles,
and/or a plurality of numbers, each one defining the concentration of a respective chemical element within the composition of said nanoparticles.

25. The method according to claim 19, wherein said unique code is composed of:
a letter that identifies a reference chemical element of the composition of said nanoparticles,
and/or a series of numbers, each one defining the relative concentration, with respect to said reference element, of other elements of said composition of said nanoparticles, said other elements being used as encoding elements.

26. The method according to claim 19, wherein said second step occurs by way of introduction and/or embedding of a nanoparticle-based substance in a matrix constituted by raw material of said object.

27. The method according to claim 19, wherein said second step occurs by way of a distributed surface application on one or more surfaces of said object.

28. The method according to claim 27, wherein said second step occurs by spraying a mixture comprising:
said nanoparticles,
a solvent,
a dispersant/coupling agent.

29. The method according to claim 28, wherein said mixture comprises one or more binders and/or additives.

30. The method according to claim 27, wherein said second step occurs by co-formulating said nanoparticles with an ink for screen printing and/or digital printing and/or for surface decoration and by applying said ink to at least one of the surfaces of said object.

31. The method according to claim 27, wherein said second step occurs by electrochemically depositing a layer of said nanoparticles, by way of a surface treatment of the galvanic type on said object.

32. The method according to claim 19, wherein said second step occurs by providing a label by way of the application of a uniform layer of said nanoparticles on an area in order to form a tag to be applied locally to said object.

33. The method according to claim 19, wherein said third step is performed by way of a preset one of the following methods and/or apparatuses:
atomic absorption spectroscopy (AAS),
inductively coupled plasma mass spectrometry (ICP-MS),
atomic emission spectroscopy (AES),
XRF spectrophotometry,
scanning electron microscope, of the SEM-EDX type.

34. The method according to claim 19, wherein an NFT is associated with said unique code.

35. An identification element comprising:
at least one of (1) nanoparticles applied to raw materials of an object and (2) nanoparticles applied to a finished object in order to authenticate/identify/trace the object and/or finished object.

36. An identification element for authenticating/identifying/tracing an object, comprising:
a nanoparticle-based substance adapted to be applied to/associated with raw materials of said object and/or to/with a finished object.
